(19) United States
(12) Patent Application Publication
(10) Pub. No.: US 2021/0268412 A1
(43) Pub. Date: Sep. 2, 2021

(54) STRAINER FOR STEAM TRAP APPARATUS

(71) Applicants: Soon Ung OH, Daejeon (KR); ECO-STEAMER CO., LTD., Daejeon (KR)

(72) Inventor: Soon Ung OH, Daejeon (KR)

(73) Assignees: ECO-STEAMER CO., LTD., Daejeon (KR); Soon Ung OH, Daejeon (KR)

(21) Appl. No.: 17/258,196

(22) PCT Filed: Jul. 2, 2019
(86) PCT No.: PCT/KR2019/008014

§ 371 Date: Jan. 6, 2021

(30) Foreign Application Priority Data
Jul. 6, 2018 (KR) 10-2018-0078653

(51) Int. Cl. B01D 35/28; F16T 1/38

(52) U.S. Cl. CPC B01D 35/28; F16T 1/38

(57) ABSTRACT

Proposed is a steam trap device strainer including: an intake pipe through which condensate water flows inside; a pressure gauge disposed at a side of the intake pipe; an intake chamber communicating with the intake pipe; a filter net disposed at a center in the intake chamber and configured to remove foreign substances; a foreign substance outlet formed at a lower portion of the intake chamber to discharge foreign substances; an intermediate channel formed over the filter net and laterally bending and extending; and a discharge pipe communicating with the intake chamber through the intermediate channel to discharge condensate water. The steam trap device further includes an intermediate chamber disposed at a bending of the intermediate channel, an adjuster assembly disposed in the intermediate chamber and having a plurality of perpendicular tunnels, and a temperature sensor disposed on a side of the discharge pipe in the strainer.

### TECHNICAL FIELD

The present disclosure relates to a strainer and, more particularly, a strainer that can be used for a steam trap device by including an orifice and a plurality of perpendicular tunnels having different diameters.

### BACKGROUND ART

A strainer is installed in the present device and prevents foreign substances such as sand, scale, rust, and metal wastes from entering parts at the rear end of a metal net by filtering out the foreign substance, and the filtered foreign substances are discharged through a drain.

A steam trap is used in various facilities, such as a factory or an office equipped with a heat exchanger and using steam as heating source, to automatically discharge condensate water that is produced in equipment using steam and in steam pipes between the equipment. That is, a steam trap is a device that discharges condensate water by operating a driving unit therein on the basis of buoyancy or a temperature difference when condensate water is collected.

Such a stem trap device is used to smoothly discharge condensate water produced in steam facilities such as a heater, a drier, and heating equipment that use high-temperature and high-pressure steam produced by a boiler in a heat exchanger, and in steam pipes connecting the boiler and the steam facilities without leakage of the steam. For example, when condensate water remains in a steam facility, the heating efficiency of the facility decreases, the quality of products is deteriorated by a temperature difference, and the operation of a factory is made unstable.

Further, condensate water remaining in a steam pipe causes steam hammer that is very dangerous, and interferes with safe operation of a factory. Steam hammer is a phenomenon in which condensate water remaining in a steam pipe is pushed to be a large lump by steam and hits against a bending of pipe or a valve and a phenomenon in which when condensate water remaining in a steam pipe comes in contact with steam, the steam is immediately condensed and the steam volume becomes zero, whereby the condensate water flows and hits against a local vacuum portion.

A steam trap usually needs a strainer and employs a filter that is a cylindrical metal net being open upward and downward and having an angle of about 45 degrees to the portion through which condensate water flows inside.

However, such a steam trap device has a problem that wear is generated therein by strong re-vaporizing steam of condensate water finally passing through an orifice and it is difficult to control the flow of fluid.

Further, it is difficult to mount an orifice member in the steam strap device due to a structural problem.

Further, when it is required to measure the accurate pressure of steam that is supplied into a steam pipe, it is necessarily required to separate a flange, etc., connect a flange having a pressure gauge, and the measure pressure.

### DISCLOSURE

### Technical Problem

In order to solve the problems described above, an objective of the present disclosure is to provide a strainer in which since there is a pressure gauge-exclusive plug is disposed at a side the inlet, it is possible to close a pressure gauge-mounting port and connect a pressure gauge, if necessary.

Another objective of the present disclosure is to provide a steam trap device in which an adjuster assembly having a plurality of perpendicular tunnels having different diameters can flow of condensate water through the perpendicular tunnels in accordance with situations.

Another objective of the present disclosure is to install an orifice member on a filter net such that the orifice member can be easily combined with a steam trap device.

### Technical Solution

In order to achieve the objectives of the present disclosure, there is provided a strainer including: an intake pipe through which condensate water flows inside; a pressure gauge disposed at a side of the intake pipe; an intake chamber communicating with the intake pipe; a filter net disposed at a center in the intake chamber and removing foreign substances; a foreign substance outlet formed at a lower portion of the intake chamber to discharge foreign substances; an intermediate channel formed over the filter net and laterally bending and extending; and a discharge pipe communicating with the intake chamber through the intermediate channel to discharge condensate water.

A flow guide guard may be further disposed between the intake pipe and the intake chamber.

An anti-scale floating guard may be formed in the intake chamber under the intake pipe.

The strainer may include: an intermediate chamber formed at a bending of the intermediate channel; an adjuster assembly disposed in the intermediate chamber and having a plurality of perpendicular tunnels; and a temperature sensor disposed on a side of the discharge pipe.

The adjuster assembly may include: an adjuster having an outer diameter corresponding to an inner diameter of the intermediate chamber and having a lever groove therein; and a clamp disposed over the adjuster and operated by an adjuster lever to bring the adjuster in close contact with the intermediate chamber, in which the perpendicular tunnels formed in the adjuster may have a circular cross-section, may have different diameters, and may be extended from a lower portion of the adjuster and perpendicularly bent through a side of the adjuster.

A first channel may be disposed between the intermediate chamber and the filter net, and a guide channel for guiding condensate water to the perpendicular tunnels may be formed at side of the first channel.

An orifice member may be further included between the intermediate chamber and the discharge pipe.

An end of the orifice member may be coupled to the discharge pipe.

An orifice member and an orifice casing covering the orifice member may be further included under the intermediate chamber.

A thermometer plug may be disposed between the intermediate chamber and the discharge pipe to check leakage of steam.

Arear chamber may be formed between the orifice member and the discharge pipe, a rear adjuster assembly may be disposed in the rear chamber, the rear adjuster assembly may include: an adjuster having an outer diameter corresponding to an inner diameter of the rear chamber, covered with an adjuster assembly casing, and having a lever groove therein; and a clamp disposed over the adjuster and operated by the adjuster to bring the adjuster in close contact with the adjuster assembly casing, in which the perpendicular tunnels formed in the adjuster may have a circular cross-section, may have different diameters, and may be extended from a lower portion of the adjuster and perpendicularly bent through a side of the adjuster.

The adjuster assembly casing may have a side channel communicating with the perpendicular tunnels on a side, and a bottom member having a bottom channel that is a straight groove therein may be inserted in a lower open portion of the adjuster assembly casing.

### Advantageous Effects

According to the present disclosure, there is an advantage that since there is a pressure gauge-exclusive plug is disposed at a side the inlet, it is possible to close a pressure gauge-mounting port and connect a pressure gauge, if necessary,

Further, since an adjuster assembly having a plurality of vertical tunnels having different diameters, it is possible to adjust flow of condensate water through the vertical tunnels in accordance with situations.

Further, an orifice member is installed on a filter net such that the orifice member can be easily combined with a steam trap device.

### DESCRIPTION OF DRAWINGS

FIG. 1 is a view showing a strainer according to the present disclosure;

FIG. 2 is a cross-sectional view showing the configuration of a first embodiment of the steam trap device according to the present disclosure;

FIG. 3 is a cross-sectional view showing the configuration of a second embodiment of the steam trap device according to the present disclosure.

FIG. 4 is a cross-sectional view showing the configuration of an adjuster assembly of the steam trap device according to the present disclosure;

FIG. 5 is a plan view showing the inside of an intermediate chamber of the steam trap device according to the present disclosure;

FIG. 6 shows a cross-section and the bottom of an adjuster of the adjuster assembly of the steam trap device according to the present disclosure;

FIG. 7 shows various types of a tunnel formed in the adjuster of the steam trap device according to the present disclosure;

FIG. 8 is a cross-sectional view showing the configuration of a third embodiment of the steam trap device according to the present disclosure;

FIG. 9 is a cross-sectional view showing the configuration of a fourth embodiment of the steam trap device according to the present disclosure; and

FIG. 10 shows a cross-section of an adjuster assembly casing of the steam trap device according to the present disclosure and shows a bottom member seen from above.

### BEST MODE

Hereinafter, embodiments of the present disclosure will be described in detail with reference to the accompanying drawings. It should be noted that when components are given reference numerals in the drawings, the same components are given the same reference numerals even if they are shown in different drawings. Further, when a component may make the spirit of the present disclosure unclear, the component is not described in detail. Further, it should be noted that although embodiments of the present disclosure will be described below, the spirit of the present disclosure is not limited thereto and may be achieved by those skilled in the art.

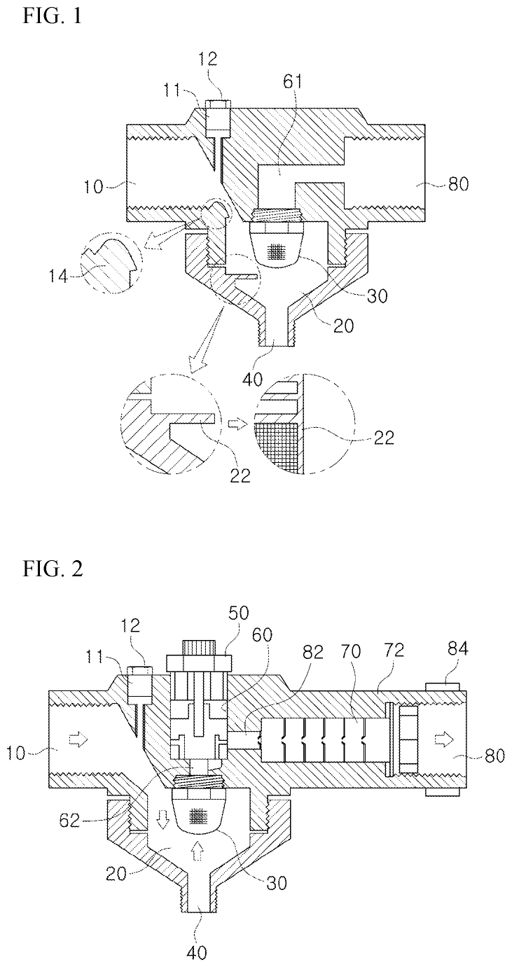

FIG. 1 is a view showing a strainer according to the present disclosure.

Hereafter, a strainer according to an exemplary embodiment of the present disclosure is described with reference to FIG. 1.

A strainer according to the present disclosure is divided into an upper body and a lower body. The upper body has an intake pipe 10, a protrusive coupling portion communicating with the intake pipe 10 and being open to be coupled to the lower body, an intermediate channel formed over the protrusive coupling portion, and a discharge pipe 80 communicating with the intermediate channel 61. The lower body has an intake chamber 20 coupled to the outer surface of the protrusive coupling portion and a foreign substance outlet 40 formed at the lower portion of the intake chamber 20.

In detail, the intake pipe 10 is a pipe through which condensate water flows inside, and has a pressure gauge plug 11 having a pressure gauge 12 in a side of the intake pipe 10.

The intake pipe 10 and the intake chamber 20 communicate with each other, and a filter net 30 for removing foreign substances is disposed at the center in the intake chamber 20. The filter net 30 is thread-fastened to the lower end of the intermediate channel 61 and filters out foreign substances such as scale. Foreign substances filtered by the filter net 40 are discharged down to the foreign substance outlet 40.

The intermediate channel 61 extends upward from the portion at which the filter net 30 is thread-fastened, laterally bends, and extends to the discharge pipe 80.

The strainer according to the present disclosure may have a flow guard 14 between the intake pipe 10 and the intake chamber 20.

In detail, the flow guard 14, which is a guard protruding upward at the portion bending toward the intake chamber 20 from the intake pipe 20, guides fluid behind the filter net 30 such that the fluid flows downward while naturally rotating.

An anti-scale floating guard 22 may be formed in the intake chamber 20 under the intake pipe 10.

In detail, the anti-scale floating guard 22 laterally extends from the inner surface of the intake chamber 20 and has a mesh, thereby keeping foreign substances such as scale in the mesh such that scale is pushed to the outlet by fluid under predetermined pressure when a scale discharge valve is opened.

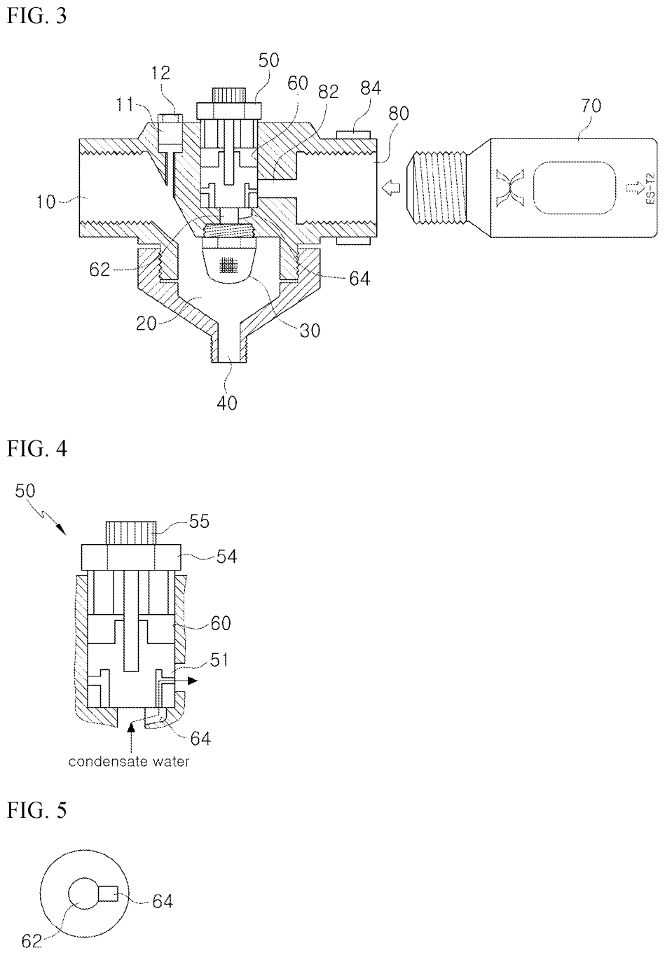

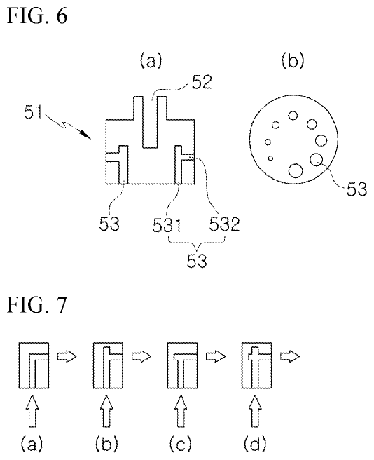

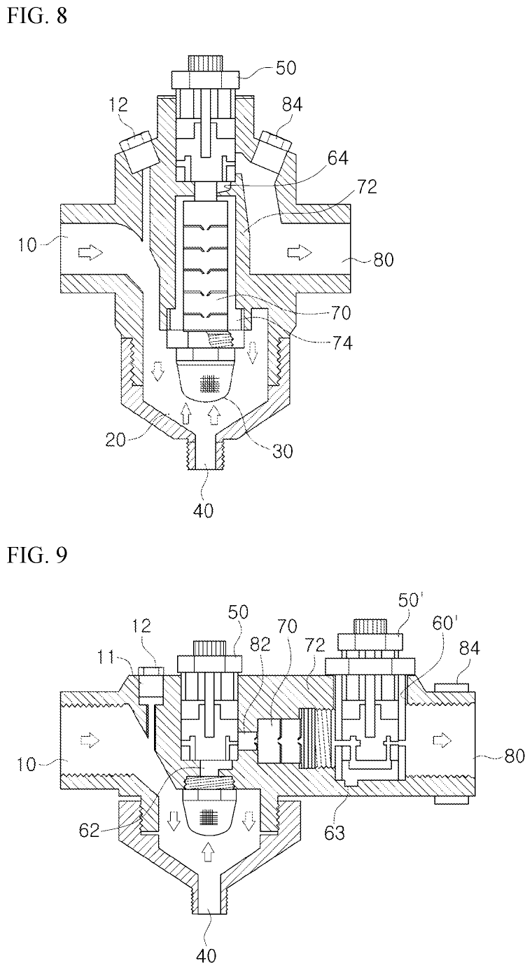

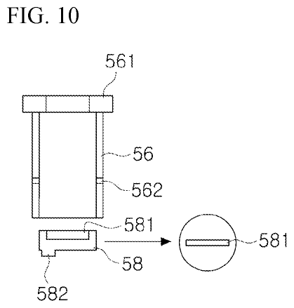

FIG. 2 is a cross-sectional view showing the configuration of a first embodiment of the steam trap device according to the present disclosure, FIG. 3 is a cross-sectional view showing the configuration of a second embodiment of the steam trap device according to the present disclosure, FIG. 4 is a cross-sectional view showing the configuration of an adjuster assembly of the steam trap device according to the present disclosure, FIG. is a plan view showing the inside of an intermediate chamber of the steam trap device according to the present disclosure, FIG. 6 shows a cross-section and the bottom of an adjuster of the adjuster assembly of the steam trap device according to the present disclosure, FIG. 7 shows various types of a tunnel formed in the adjuster of the steam trap device according to the present disclosure, FIG. 8 is a cross-sectional view showing the configuration of a third embodiment of the steam trap device according to the present disclosure, FIG. 9 is a cross-sectional view showing the configuration of a fourth embodiment of the steam trap device according to the present disclosure, FIG. 10 shows a cross-section of an adjuster assembly casing of the steam trap device according to the present disclosure and shows a bottom member seen from above.

Hereafter, a steam trap device according to exemplary embodiments of the present disclosure is described with reference to FIGS. 2 to 10.

A steam trap device according to an exemplary embodiment of the present disclosure includes an adjuster assembly 50 installed in the intermediate chamber 60 formed in the intermediate channel 61 of the strainer, and an orifice member 70 through which condensate water passes.

In detail, the steam trap device according to an exemplary embodiment of the present disclosure includes: an upper body having an intake pipe 10, a discharge pipe 80, an intermediate chamber 60 formed between the intake pipe 10 and the discharge pipe 80, and a protrusive coupling portion being open under the intermediate chamber 60; and a lower body having an intake chamber 20 and coupled to the protrusive coupling portion.

In detail, referring to FIG. 2, the steam trap device according to a first embodiment of the present disclosure includes an intake pipe 10, a pressure gauge 12, an intake chamber 20, a filter net 30, a foreign substance outlet 40, an intermediate chamber 60, an adjuster assembly 50, an orifice member 70, and a discharge pipe 80.

The intake pipe 10, which passes condensate water, has an end connected to a steam line (not shown) of steam equipment and another end passing through the upper portion of the intake chamber 20.

The pressure gauge 12 is disposed on a pressure gauge plug 11 on a side of the intake pipe 10, so pressure at the upstream side in the steam trap can be measured. Further, it is also possible to measure negative pressure by opening a downstream gate valve of the steam trap with an upstream gate valve open.

The intake chamber 20 communicating with the intake pipe 10 is formed in a cylindrical shape such that condensate water that has passed through the intake pipe 10 flows down into a lower space from an upper space. Further, the inside of the intake pipe 10 is inclined down toward the center such that condensate water and foreign substances can be collected at the center, and has an outlet 40 at the lower end to discharge foreign substances.

The filter net 30 for removing foreign substances is disposed at the center in the intake chamber 20. The filter net 30 is separably thread-fastened to the lower portion of the intermediate chamber 60.

A valve is disposed in the foreign substance outlet 40 to discharge foreign substances such as scale filtered by the filter net 30.

A first channel 62 smaller in diameter than the filter net 30 and the intermediate chamber 60 may be formed between the filter net 30 and the intermediate chamber 60, and a guide channel 64 is formed at a side of the first channel 62 to communicate with perpendicular tunnels 53 of the adjuster assembly 50. Condensate water is guided to the tunnels 53 by the guide channel 64.

The adjuster assembly 50 having a plurality of perpendicular tunnels 53 is disposed in the intermediate chamber 60 over the filter net 30. The adjuster assembly 50 will be described in detail below.

A second channel 82, a fixing portion 72 for installing the orifice member 70, and the outlet 80 are sequentially positioned on a side of the intermediate chamber 60, and a temperature sensor 84 is disposed on a side of the discharge pipe 80.

The adjuster assembly 50 is described with reference to FIGS. 4 to 7.

The adjuster assembly 50 is composed of an adjuster 51, a clamp 54, and an adjuster lever 55. In detail, the adjuster 51 has an outer diameter corresponding to the internal space of the intermediate chamber 60 and has a lever hole 52 therein.

The clamp 54 disposed over the adjuster 51 is operated by the adjuster lever 55 to bring the adjuster 51 in close contact with the intermediate chamber 60.

The perpendicular tunnels 53 formed in the adjuster 51 have a circular cross-section and have different diameters.

Referring to FIG. 6(b), the tunnels 53 having different sizes are circularly disposed on the bottom of the adjuster 51. The tunnels 53 may be sequentially disposed from a tunnel 53 with a small diameter to a tunnel 53 with a large diameter.

The tunnels 53 are a first tunnel 531 formed upward from the lower end and a second tunnel 532 communicating with the first tunnel 531 and extending toward the side of the adjuster 51. That is, the tunnels 53 are vertical channels formed such that condensate water is sent from the bottom and then can be laterally discharged.

The perpendicular joint between the first tunnel 531 and the second tunnel 532 may be implemented in various shapes, as shown in FIG. 6, and the resistance (flow speed) of condensate water depends on the shapes of the tunnels, so appropriate shapes can be selected for purposes.

Since a vortex is generated by resistance at the joint between the first tunnel 531 and the second tunnel 532, there is an advantage that it is possible to adjust the flow of condensate water by maximizing the effect of pressure reduction.

The adjuster assembly 50 checks an appropriate temperature through the temperature sensor 84 disposed on the discharge pipe 80, selects a perpendicular tunnel 53 having a diameter that can provide an appropriate fluid flow on the basis of the temperature measured by the temperature sensor 84, adjusts the perpendicular tunnel 53 to a position where it communicates with the guide channel 64, and is then tightened to be fixed by the clamp 54.

Referring to FIG. 3, in a steam trap device according to a second embodiment of the present disclosure, the orifice member 70 is provided in an external separate type.

Accordingly, the fixing portion 72 for installing the orifice member 70 between the second channel 82 and the discharge pipe 80 is not provided.

An end of the orifice member 70 is smaller in diameter than the other portion and has a thread on the outer surface, so the orifice member 70 can be combined with the discharge pipe 80.

When the orifice function is achieved only by the perpendicular tunnels 53 of the adjuster 51, depending on situations, the orifice member 70 may also be removed.

This configuration is the same as the steam trap device according to the preset disclosure, so it is not described.

A steam trap device according to a third embodiment of the present disclosure is described with reference to FIG. 8. Similar to the description of the steam trap device according to the second embodiment, the configuration the same as those of the first embodiment and the second embodiment is not described.

A steam trap device according to the third embodiment of the present disclosure may has a fixing portion 72 under the intermediate chamber 80, an orifice member 70 coupled to the fixing portion 72, and an orifice casing 74 covering the orifice member 70.

In this embodiment, the orifice member 70 is inserted in the orifice casing 74 and disposed in the fixing portion 72 with the filter net 30 thread-fastened to the inlet thereof.

This structure has the advantage that the orifice member 70 can be simply coupled to the steam trap device.

A thermometer plug 84 is disposed between the intermediate chamber 60 and the discharge pipe 80 and checks leakage of steam.

Referring to FIGS. 9 and 10, a steam trap device according to a fourth embodiment of the present disclosure may include two adjuster assemblies 50.

In detail, the steam trap device according to a fourth embodiment of the present disclosure, which is an example modified from the steam trap device according to the first embodiment, further includes another adjuster assembly between the orifice 70 and the discharge pipe 80.

In detail, a rear chamber 60′ is disposed between the orifice 70 and the discharge pipe 80, and a rear adjuster assembly 50′ is disposed in the rear chamber 60′.

A fitting hole 63 recessed downward is formed on the bottom of the rear chamber 60′.

The rear adjuster assembly 50′ has the same configuration as the adjuster assembly 50 and may have a longer clamp 54.

Further, the rear adjuster assembly 50′ has an adjuster assembly casing 56 covering the rear adjuster assembly 50′.

The adjuster assembly casing 56 has a space therein that can accommodate the rear adjuster assembly 50′, and is open downward.

A head 561 larger in diameter than the inlet of the rear chamber 60′ is disposed on the adjuster assembly casing 56 and has a side channel 562 on a side at a height corresponding to a second tunnel 532′ of a perpendicular channel 53′ of the rear adjuster assembly 50′.

A bottom member 58 is disposed on the open lower portion of the adjuster assembly casing 56′.

A fitting portion 582 is formed at a side on the bottom of the bottom member 58 and is fitted in the fitting hole 63. Accordingly, the adjuster assembly casing 56 is maintained at a predetermined position.

Referring to the plan view of the bottom plate in FIG. 10, a bottom channel 581 that is a straight channel is formed on the inner bottom of bottom member 58 communicate with the perpendicular tunnel 53.

The top of the bottom member 58 and the bottom of the adjuster 510 are in close contact with each other such that condensate water passing through the rear adjuster assembly 50′ cannot leak through portions other than the channel formed by the perpendicular channel 53′ and the bottom channel 581.

The steam trap device according to the fourth embodiment generates negative pressure again using the rear adjuster assembly 50′, it is possible to maximize the diameter of the orifice member. Accordingly, there is an advantage that it is possible to minimize clogging that may be generated and to reduce the number of orifice members 70.

As described above, since the steam trap devices according to the present disclosure includes an adjuster assembly 50 having perpendicular tunnels having different diameters, it is possible to provide a channel having an appropriate diameter, depending on situations. Further, since a pressure gauge plug 11 is provided, it is possible to simplify the process of measurement.

The above description merely explains the spirit of the present disclosure and the present disclosure may be changed, modified, and replaced in various ways without departing from the spirit of the present disclosure by those skilled in the art. Accordingly, the embodiments of the present disclosure and the accompanying drawings are provided to describe the present disclosure rather limiting the spirit of the present disclosure, and the spirit of the present disclosure is not limited by the embodiments and the accompanying drawings. The protective range of the present disclosure should be construed by the following claims and the scope and spirit of the present disclosure should be construed as being included in the patent right of the present disclosure.

1. A steam trap device strainer comprising:
an intake pipe through which condensate water flows inside;
a pressure gauge disposed at a side of the intake pipe;
an intake chamber communicating with the intake pipe;
a filter net disposed at a center in the intake chamber and configured to remove foreign substances;
a foreign substance outlet formed at a lower portion of the intake chamber to discharge foreign substances;
an intermediate channel formed over the filter net and laterally bending and extending; and
a discharge pipe communicating with the intake chamber through the intermediate channel to discharge condensate water.

2. The steam trap device strainer of claim 1, further comprising a flow guide guard provided between the intake pipe and the intake chamber.

3. The steam trap device strainer of claim 1, further comprising an anti-scale floating guard provided in the intake chamber under the intake pipe.

4. The steam trap device strainer of claim 1, further comprising:
an intermediate chamber formed at a bending of the intermediate channel;
an adjuster assembly disposed in the intermediate chamber and having a plurality of perpendicular tunnels; and
a temperature sensor disposed on a side of the discharge pipe.

5. The steam trap device strainer of claim 4, wherein the adjuster assembly comprises:
an adjuster having an outer diameter corresponding to an inner diameter of the intermediate chamber and having a lever groove therein; and
a clamp disposed over the adjuster and operated by an adjuster lever to bring the adjuster in close contact with the intermediate chamber,
wherein the perpendicular tunnels formed in the adjuster have a circular cross-section, have different diameters, and are extended from a lower portion of the adjuster and perpendicularly bent through a side of the adjuster.

6. The steam trap device strainer of claim 4, wherein a first channel is disposed between the intermediate chamber and the filter net, and a guide channel for guiding condensate water to the perpendicular tunnels is formed at side of the first channel.

7. The steam trap device strainer of claim 4, further comprising an orifice member provided between the intermediate chamber and the discharge pipe.

8. The steam trap device strainer of claim 4, wherein an end of the orifice member is coupled to the discharge pipe.

9. The steam trap device strainer of claim 4, wherein an orifice member and an orifice casing covering the orifice member are further provided under the intermediate chamber.

10. The steam trap device strainer of claim 9, wherein a thermometer plug is provided between the intermediate chamber and the discharge pipe to check leakage of steam.

11. The steam trap device strainer of claim 7, further comprising:
a rear chamber formed between the orifice member and the discharge pipe; and
a rear adjuster assembly disposed in the rear chamber,
wherein the rear adjuster assembly comprises:
an adjuster having an outer diameter corresponding to an inner diameter of the rear chamber, covered with an adjuster assembly casing, and having a lever groove therein; and
a clamp disposed over the adjuster and operated by the adjuster to bring the adjuster in close contact with the adjuster assembly casing,
wherein the perpendicular tunnels formed in the adjuster have a circular cross-section, have different diameters, and are extended from a lower portion of the adjuster and perpendicularly bent through a side of the adjuster.

12. The steam trap device strainer of claim 11, wherein the adjuster assembly casing has a side channel communicating with the perpendicular tunnels on a side, and
a bottom member is inserted in a lower open portion of the adjuster assembly casing, the bottom member having a bottom channel that is a straight groove therein.

13. The steam trap device strainer of claim 2, further comprising:
an intermediate chamber formed at a bending of the intermediate channel;
an adjuster assembly disposed in the intermediate chamber and having a plurality of perpendicular tunnels; and
a temperature sensor disposed on a side of the discharge pipe.

14. The steam trap device strainer of claim 3, further comprising:
an intermediate chamber formed at a bending of the intermediate channel;
an adjuster assembly disposed in the intermediate chamber and having a plurality of perpendicular tunnels; and
a temperature sensor disposed on a side of the discharge pipe.

15. The steam trap device strainer of claim 13, wherein the adjuster assembly comprises:
an adjuster having an outer diameter corresponding to an inner diameter of the intermediate chamber and having a lever groove therein; and
a clamp disposed over the adjuster and operated by an adjuster lever to bring the adjuster in close contact with the intermediate chamber,
wherein the perpendicular tunnels formed in the adjuster have a circular cross-section, have different diameters, and are extended from a lower portion of the adjuster and perpendicularly bent through a side of the adjuster.

16. The steam trap device strainer of claim 13, wherein a first channel is disposed between the intermediate chamber and the filter net, and a guide channel for guiding condensate water to the perpendicular tunnels is formed at side of the first channel.

17. The steam trap device strainer of claim 13, further comprising an orifice member provided between the intermediate chamber and the discharge pipe.

18. The steam trap device strainer of claim 13, wherein an end of the orifice member is coupled to the discharge pipe.

19. The steam trap device strainer of claim 13, wherein an orifice member and an orifice casing covering the orifice member are further provided under the intermediate chamber.

20. The steam trap device strainer of claim 19, wherein a thermometer plug is provided between the intermediate chamber and the discharge pipe to check leakage of steam.
